(19) United States
(12) Patent Application Publication
(10) Pub. No.: US 2014/0047101 A1
(43) Pub. Date: Feb. 13, 2014

(54) Method for Personalized Shopping Recommendations

(71) Applicants: William Nix, Austin, TX (US); Clint H. O'Connor, Austin, TX (US); Michael Haze, Round Rock, TX (US); Yuan-Chang Lo, Austin, TX (US)

(72) Inventors: William Nix, Austin, TX (US); Clint H. O'Connor, Austin, TX (US); Michael Haze, Round Rock, TX (US); Yuan-Chang Lo, Austin, TX (US)

(21) Appl. No.: 13/570,495

(22) Filed: Aug. 9, 2012

(51) Int. Cl. G06F 15/173

(52) U.S. Cl. 709/224

(57) ABSTRACT

A system, method, and computer-readable medium are disclosed for providing personalized recommendations based upon a user's system profile and usage. A personalized recommendation system receives a first set of input data and a second set of input data, the first set of input data comprising traditional recommendation input data and the second set of input data comprising recommendation input data associated with the profile and usage of a user's system. The first and second sets of input data are then processed to generate and provide a personalized recommendation.

### BACKGROUND OF THE INVENTION

1. Field of the Invention

The present invention relates to the management of information handling systems. More specifically, embodiments of the invention provide a system, method, and computer-readable medium for providing personalized recommendations based upon a user's system profile and usage.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

These same information handling systems have played a key role in the rapid growth of electronic commerce on the Internet. In recent years, information handling systems have also been instrumental in the widespread adoption of social media into the mainstream of everyday life. Social media commonly refers to the use of web-based technologies for the creation and exchange of user-generated content for social interaction. More recently, various aspects of social media have become an increasingly popular for enabling a viable marketing channel for vendors. This new marketing channel, sometimes referred to as “social marketing,” has proven to not only have a higher customer retention rate than traditional marketing channels, but to also provide higher demand generation “lift”

It has become common for merchants and other types of organizations to use recommendation systems to dynamically present special offers. Such offers are typically presented in the context of recommendations for predetermined products, product offers or deals, and content (e.g., articles, videos, ratings, reviews, etc.). The recommendations are typically based on the user's perceived value, or importance, to the organization with the goal of inducing an interaction with the user. Likewise, social score recommendations can be combined with other types of recommendations and algorithms to further target offers to users based not only upon their social score, but other factors that increase the likelihood of the user to take action and interact with the recommendation.

However, most recommendation systems provide recommendations that are based upon a combination of prior purchases, ratings of prior purchases, and ratings from other shoppers. As such, they typically fail to take into account other factors, such as the user's system configuration (e.g., printers, scanners, etc.), the applications that are typically used by the user, or what they are used for (e.g., word processing, photo or video editing, etc.). As a result, the content (e.g., products, promotions, etc.) they contain are often static and are not presented in the context of the hardware and software configuration of the user's system or how they use it. Furthermore, such recommendations generally fail to provide personalized recommendations that guide the user in selecting products or services that would increase the efficiency or effectiveness of their system or its usage. As a result, the likelihood of a sales conversion resulting from the recommendation is diminished.

### SUMMARY OF THE INVENTION

A system, method, and computer-readable medium are disclosed for providing personalized recommendations based upon a user's system profile and usage. In various embodiments, a personalized recommendation system receives a first set of input data and a second set of input data, the first set of input data comprising traditional recommendation input data and the second set of input data comprising recommendation input data associated with the profile and usage of a system associated with a user. The first and second sets of input data are then processed to generate and provide a personalized recommendation. In one embodiment, the personalized recommendation is displayed within a window of a user interface associated with the user's system.

In various embodiments, the traditional recommendation input data may include data associated with a user's past searches, a user's past purchases, a user's product ratings, other user's purchases and ratings, and a user's customer segment. The traditional recommendation input data may likewise include data associated with purchases and rating from users within the user's customer segment and purchases, ratings from users within the user's social network, and a user preference profile. Likewise, the system profile and usage recommendation input data comprises data associated with the user's system hardware configuration and capability, software usage profiling, and purchases and ratings from users with similar system profiles and usage. The system profile and usage recommendation input data may likewise comprise data associated with software installed on the user's system, hardware usage profiling, and peripherals attached to the user's system.

In these and other embodiments, the personalized recommendation system may comprise a system profile and usage profiler system. In one embodiment, the system profile and usage profiler system is operable to receive system profile and usage recommendation input data from a system profile and usage profiler agent implemented on a user's system. In another embodiment, the system profile and usage profiler system is operable to collect system profile and usage recommendation input data directly from a user's system over a network connection. In these and various other embodiments, the system profile and usage recommendation input data is contained within a system and usage profile.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of recommendation operations performed to provide a personalized recommendation based upon a user's system profile and usage; and

FIG. 3 is a generalized flow chart of the performance of recommendation operations to provide a personalized recommendation based upon a user's system profile and usage.

### DETAILED DESCRIPTION

A system, method, and computer-readable medium are disclosed for providing personalized recommendations based upon a user's system profile and usage. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

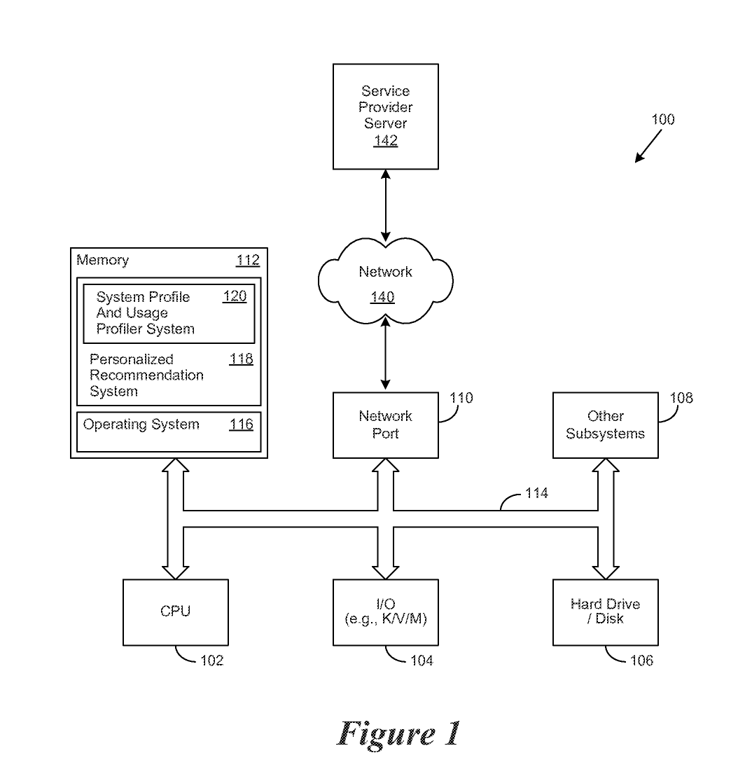

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a personalized recommendation system 118, which in turn may comprise a system profile and usage profiler system 120. In one embodiment, the information handling system 100 is able to download the personalized recommendation system 118 from the service provider server 142. In another embodiment, the personalized recommendation system 118 is provided as a service from the service provider server 142.

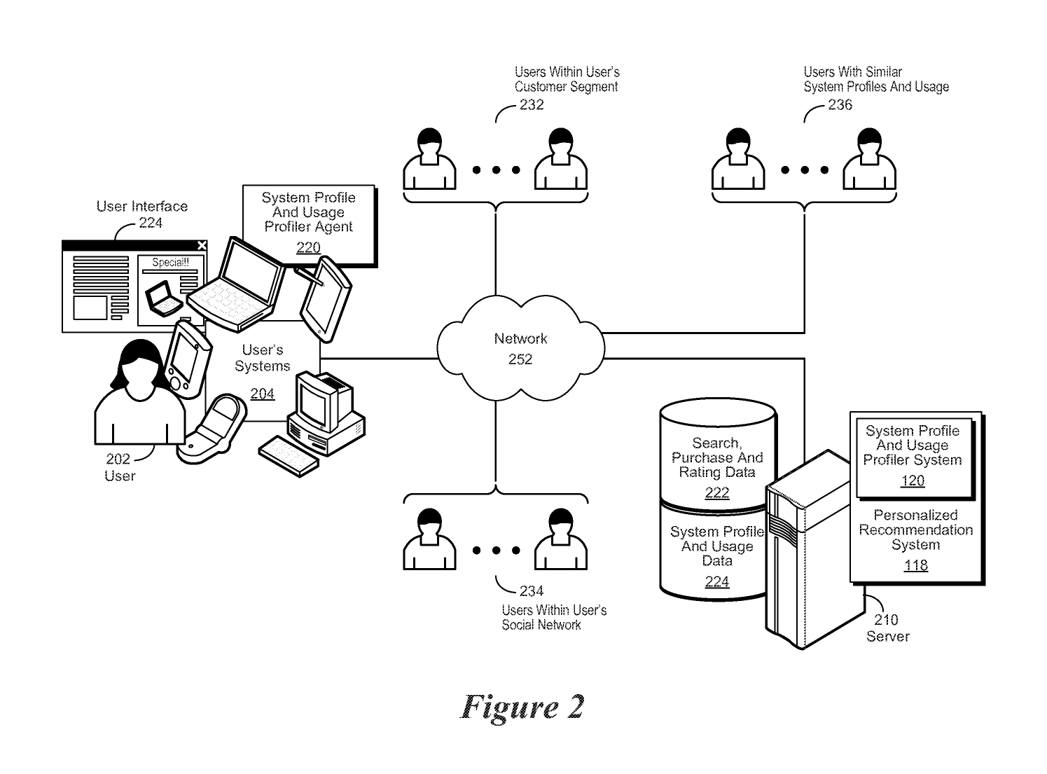

FIG. 2 is a simplified block diagram of recommendation operations performed in accordance with an embodiment of the invention to provide a personalized recommendation based upon a user's system profile and usage. In various embodiments, a personalized recommendation system 118 is implemented to generate personalized recommendations according to the combination of traditional recommendation input data and input data corresponding to a user's system profile and usage. In these and other embodiments, the personalized recommendation system 118 may comprise a system profile and usage profiler system 120. In one embodiment, the system profile and usage profiler system 120 is operable to receive system profile and usage recommendation input data from a system profile and usage profiler agent 220 implemented on a user's system 204. In another embodiment, the system profile and usage profiler system 120 is operable to collect system profile and usage recommendation input data directly from a user's system over a network connection 252. In these and various other embodiments, the system profile and usage recommendation input data is contained within a system and usage profile.

As used herein, a user's system 204 may comprise a personal computer, a laptop computer, or a tablet computer operable to establish an on-line session with the personalized recommendation system 118 over a connection to network 252. The user's system 204 may also comprise a personal digital assistant (PDA), a mobile telephone, or any other suitable device operable to establish a connection with network 252, provide the system 204 profile and usage data to the personalized recommendation system 118, and receive a personalized recommendation in return. In these various embodiments, the personalized recommendation is displayed to the user 202 within a user interface 226 associated with the user's system 204.

In various embodiments, the personalized recommendation system 118 may also comprise a repository of traditional search, purchase and rating data 222 and a repository of system profile and usage data 224, all of which may be implemented on one or more servers 210. In these and other embodiments, the system 204 profile and usage data provided to the personalized recommendation system 118 is stored in the repository of system profile and usage data 224. In these various embodiments, the personalized recommendation system 118 may be accessible over a connection to network 252.

In this embodiment, personalized recommendation operations are initiated by the personalized recommendation system 118 first receiving traditional recommendation input data. In various embodiments, the traditional recommendation input data is stored in the repository of search, purchase and rating data 222. As used herein, traditional recommendation input data broadly refers to data commonly used by known recommendation systems to generate a recommendation. In various embodiments, the traditional recommendation input data may include data associated with a user's 202 past searches, a user's 202 past purchases, a user's 202 product ratings, other user's purchases and ratings, and a user's 202 customer segment. The traditional recommendation input data may likewise include data associated with purchases and rating from users within the user's customer segment 232, purchases and ratings from users within the user's social network 234, and a user preference profile.

Thereafter, or concurrent with the receipt of traditional recommendation input data, the personalized recommendation system 118 receives system profile and usage recommendation input data. As used herein, system profile and usage recommendation input data broadly refers to data associated with a target user's system 204 profile and its usage by the user. In various embodiments, this system 204 profile and usage recommendation input data comprises data associated with the user's system 204 hardware configuration and capability, software usage profiling, and purchases and ratings from users with similar system profiles and usage 236. The system 204 profile and usage recommendation input data may likewise comprise data associated with software installed on the user's system 204, hardware usage profiling, and peripherals attached to the user's system 204.

The traditional recommendation input data and the system profile and usage recommendation input data is then processed by a personalized recommendation system 118 to generate personalized recommendations, which are then provided to the user 202. In various embodiments, the personalized recommendations are displayed within a user interface 226 associated with the user's system 204. As used herein, a personalized recommendation broadly refers to a recommendation that is generated based upon traditional recommendation input data, as described in greater detail herein, and also system 204 profile and usage recommendation input data.

As an example, the user's system 204 hardware, installed software, and attached peripherals could be analyzed by a system profile and usage profiler agent 228 to generate system 204 profile and usage data. In one embodiment, the analysis is performed on an ongoing basis. In another embodiment, the analysis is performed on an intermittent basis according to a predetermined schedule or by the occurrence of certain predetermined events (e.g., new peripherals being added, a software application being used, etc.). To continue this example, the system profile and usage profiler agent 228 may note that the user 202 has connected a digital camera to download pictures. As a result, the analysis may initiate a comparison to other users within the user's customer segment 232, such as digital photographers, who may use a certain monitors, printers or software. To further the example, if the user 202 has a small monitor, or a non-photo-quality printer attached to their system 204, then appropriate new products or services could be recommended.

As another example, the system profile and usage profiler agent 228 may note that a particular model of printer is connected to the user's system 204, but there is no record of the user 202 purchasing that particular model of printer. As the printer's ink or toner cartridge reaches a predetermined level, the personalized recommendation system 118 may provide the user 202 a personalized recommendation for a service that automatically delivers ink or toner cartridges when their remaining life drops to a predetermined level.

In various embodiments, analysis of the collected system profile and usage recommendation input data may provide additional insights. For example, is the user's system 204 memory or processor being maxed out, or is its storage nearing capacity? Likewise, what is the frequency and duration of usage of different software applications? Furthermore, is the user 202 using advanced software or advanced software capabilities, or are they using introductory software and only basic functions? Moreover, the use of different content types may infer the user's 202 sophistication level. For example, does the user 202 use 128 kbps MP3 files or do they use lossless FLAC files to store their music? Do they shoot photographs using JPEG or RAW formats? It will be appreciated that such insights provide the basis to provide more objective and pertinent recommendations than might be derived from traditional recommendation input data.

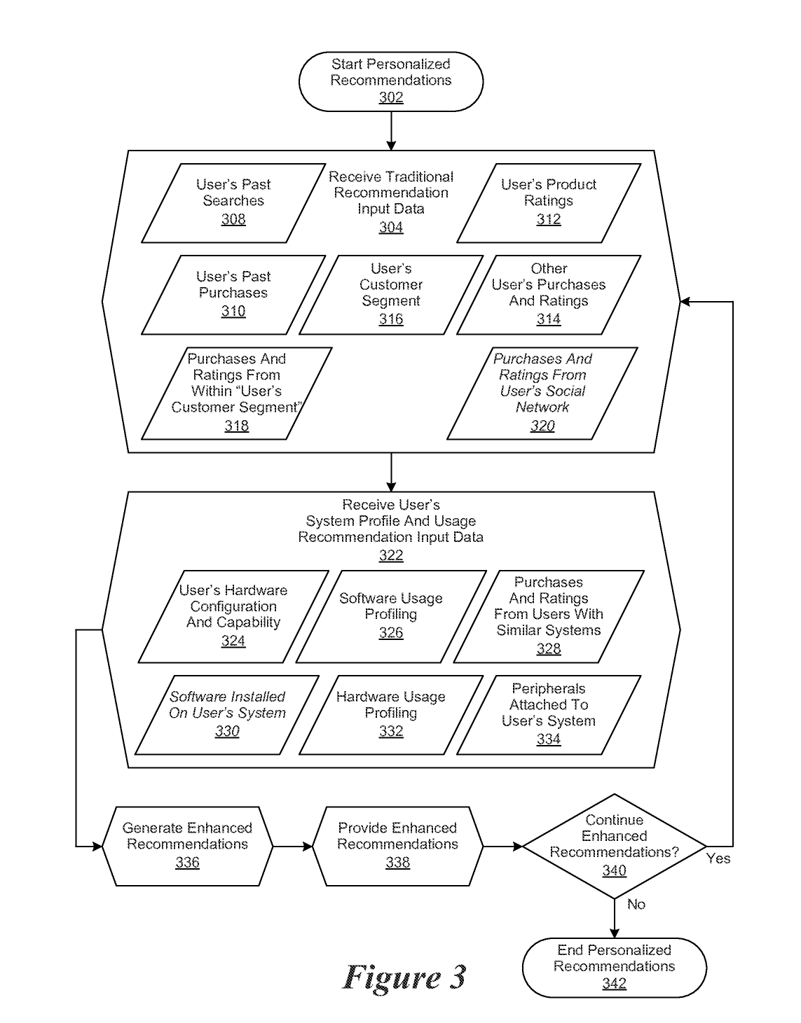

FIG. 3 is a generalized flow chart of the performance of recommendation operations in accordance with an embodiment of the invention to provide a personalized recommendation based upon a user's system profile and usage. In various embodiments, a personalized recommendation system is implemented to generate personalized recommendations according to the combination of traditional recommendation input data and input data corresponding to a user's system profile and usage.

In this embodiment, personalized recommendation operations are begun in step 302, followed by the receipt of traditional recommendation input data in step 304. In various embodiments, the traditional recommendation input data includes data associated with a user's past searches 308, a user's past purchases 310, a user's product ratings 312, other user's purchases and ratings 314, and a user's customer segment 316. Such traditional recommendation input data may likewise include data associated with purchases and rating from users within the user's customer segment 318, purchases and ratings from users within the user's social network 320, and the user's preference profile 319.

Then, in step 322, system profile and usage recommendation input data is received. In various embodiments, this system profile and usage recommendation input data comprises data associated with the user's hardware configuration and capability 324, software usage profiling 326, and purchases and ratings from users with similar system profiles and usage 328. Such system profile and usage recommendation input data may likewise comprise data associated with software installed on the user's system 330, hardware usage profiling 332, and peripherals attached to the user's system 334.

The traditional recommendation input data and the system profile and usage recommendation input data is then processed by a personalized recommendation system in step 336 to generate personalized recommendations, which are then provided to the user in step 338. A determination is then made in step 340 whether to continue personalized recommendation operations. If so, the process is continued, proceeding with step 304. Otherwise, personalized recommendation operations are ended in step 342.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed on that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for providing personalized recommendations, comprising:
receiving a first set of input data comprising recommendation input data associated with the profile and usage of a system associated with a user;
processing the first set of input data to generate personalized recommendation data; and
providing the personalized recommendation data.

2. The method of claim 1, wherein the first set of input data comprises at least one of the set of:
data associated with the user's system hardware configuration;
data associated with the user's system hardware capabilities;
data associated with the user's software usage;
data associated with purchases and ratings from users with similar system profiles and usage;
data associated with software installed on the user's system;
data associated with the user's hardware usage; and
data associated with peripherals attached to the user's system.

3. The method of claim 1, wherein the first set of input data comprises a system and usage profile associated with the user's system, the system and usage profile received from at least one of the set of:
a system and usage profiler system, and
a system and usage profiler agent associated with the user's system.

4. The method of claim 3, wherein the system and usage profile is received over a network connection.

5. The method of claim 1, wherein:
a second set of input data is received; and
the first and second set of input data are processed to generate the personalized recommendation data, the second set of input data comprising at least one of the set of:
data associated with the user's past searches;
data associated with the user's past purchases;
data associated with the user's product ratings;
data associated with other user's purchases and ratings;
data associated with the user's customer segment;
data associated with purchases and rating from users within the user's customer segment;
data associated with purchases and ratings from users within the user's social network; and
data associated with the user's preference profile.

6. The method of claim 1, wherein the provision of the personalization recommendation data comprises at least one of the set of:
displaying the personalization recommendation data within a window of a user interface associated with the user's system; and
providing the personalization recommendation data as a service.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving a first set of input data comprising recommendation input data associated with the profile and usage of a system associated with a user;
processing the first set of input data to generate personalized recommendation data; and
providing the personalized recommendation data.

8. The system 7, wherein the first set of input data comprises at least one of the set of:
data associated with the user's system hardware configuration;
data associated with the user's system hardware capabilities;
data associated with the user's software usage;
data associated with purchases and ratings from users with similar system profiles and usage;
data associated with software installed on the user's system;
data associated with the user's hardware usage; and
data associated with peripherals attached to the user's system.

9. The system of claim 7, wherein the first set of input data comprises a system and usage profile associated with the user's system, the system and usage profile received from at least one of the set of:
a system and usage profiler system, and
a system and usage profiler agent associated with the user's system.

10. The system of claim 9, wherein the system and usage profile is received over a network connection.

11. The system of claim 7, wherein.
a second set of input data is received; and
the first and second set of input data are processed to generate the personalized recommendation data, the second set of input data comprising at least one of the set of:
data associated with the user's past searches;
data associated with the user's past purchases;
data associated with the user's product ratings;
data associated with other user's purchases and ratings;
data associated with the user's customer segment;
data associated with purchases and rating from users within the user's customer segment;
data associated with purchases and ratings from users within the user's social network; and
data associated with the user's preference profile.

12. The system of claim 7, wherein the provision of the personalization recommendation data comprises at least one of the set of:
displaying the personalization recommendation data within a window of a user interface associated with the user's system; and
providing the personalization recommendation data as a service.

13. A non-transitory, computer-readable storage medium embodying computer program code, the computer program code comprising computer executable instructions configured for:
receiving a first set of input data comprising recommendation input data associated with the profile and usage of a system associated with a user;
processing the first set of input data to generate personalized recommendation data; and
providing the personalized recommendation data.

14. The non-transitory, computer-readable storage medium of claim 13, wherein the first set of input data comprises at least one of the set of:
data associated with the user's system hardware configuration;
data associated with the user's system hardware capabilities;
data associated with the user's software usage;
data associated with purchases and ratings from users with similar system profiles and usage;
data associated with software installed on the user's system;
data associated with the user's hardware usage; and
data associated with peripherals attached to the user's system.

15. The non-transitory, computer-readable storage medium of claim 13, wherein the first set of input data comprises a system and usage profile associated with the user's system, the system and usage profile received from at least one of the set of:
a system and usage profiler system, and
a system and usage profiler agent associated with the user's system.

16. The non-transitory, computer-readable storage medium of claim 15, wherein the system and usage profile is received over a network connection.

17. The non-transitory, computer-readable storage medium of claim 13, wherein:
a second set of input data is received; and
the first and second set of input data are processed to generate the personalized recommendation data, the second set of input data comprising at least one of the set of:
data associated with the user's past searches;
data associated with the user's past purchases;
data associated with the user's product ratings;
data associated with other user's purchases and ratings;
data associated with the user's customer segment;
data associated with purchases and rating from users within the user's customer segment;
data associated with purchases and ratings from users within the user's social network; and
data associated with the user's preference profile.

18. The non-transitory, computer-readable storage medium of claim 13,
wherein the provision of the personalization recommendation data comprises at least one of the set of:
displaying the personalization recommendation data within a window of a user interface associated with the user's system; and
providing the personalization recommendation data as a service.
